(19) United States
(12) Patent Application Publication
(10) Pub. No.: US 2010/0180104 A1
(43) Pub. Date: Jul. 15, 2010

(54) APPARATUS AND METHOD FOR PATCHING MICROCODE IN A MICROPROCESSOR USING PRIVATE RAM OF THE MICROPROCESSOR

(75) Inventors: G. Glenn Henry, Austin, TX (US); Terry Parks, Austin, TX (US)

Correspondence Address: HUFFMAN LAW GROUP, P.C., 1900 MESA AVE., COLORADO SPRINGS, CO, 80906, US

(73) Assignee: VIA Technologies, Inc., Taipei (TW)

(21) Appl. No.: 12/403,769

(22) Filed: Mar. 13, 2009

Related U.S. Application Data
(60) Provisional application No. 61/144,808, filed on Jan. 15, 2009.

(51) Int. Cl. G06F 9/30

(52) U.S. Cl. 712/208; 711/104; 712/E09.016

(57) ABSTRACT

A microprocessor has a microcode memory for storing original microcode instructions to implement user program instructions, and an interface to an external memory for storing a microcode patch. The microcode patch includes substitute microcode instructions and validation information. The microprocessor includes a private random access memory (PRAM), addressable by the original and substitute microcode instructions but not addressable by user program instructions. The microprocessor also includes patch hardware, which conditionally receives the substitute microcode instructions. The microprocessor executes the substitute microcode instructions when applied to the patch hardware instead of corresponding original microcode instructions. The microprocessor is configured to load the microcode patch from external memory into PRAM, determine whether the microcode patch is valid, apply substitute microcode instructions from PRAM to the patch hardware if the microcode patch is valid, and refrain from applying the substitute microcode instructions to the patch hardware, if the microcode patch is invalid.

### CROSS REFERENCE TO RELATED APPLICATIONS

This application claims priority to Provisional Application No. 61/144,808, filed on Jan. 15, 2009, which is incorporated by reference herein in its entirety for all purposes.

### FIELD OF THE INVENTION

The present invention relates in general to microprocessors, and more particularly to a secure means of loading microcode patches into a microprocessor from an external memory.

### BACKGROUND OF THE INVENTION

Microprocessors typically include microcode or microprograms. One common use of microcode is to perform initialization functions of the microprocessor after a reset. Another common microcode use is to handle micro-exceptions, i.e., exception conditions within the microprocessor that are handled by the microprocessor itself rather than, or in addition to, raising the exception to the operating system to handle. Another common microcode use is to implement complex and/or infrequently executed instructions in the instruction set architecture of the microprocessor. When the microprocessor decodes one of the microcode-implemented instructions of the instruction set, rather than sending the instruction directly to the execution units of the microprocessor to be executed, the microprocessor transfers control to the appropriate microcode routine. The microprocessor then sends the microcode instructions to the execution units that execute the instructions to implement the complex and/or infrequently executed instruction. This allows the execution units (and other units of the microprocessor, such as a dependency checking unit or retire unit) to be less complex than they would be if they had to be capable of executing all the instructions of the microprocessor instruction set, including even the complex and/or infrequently executed instructions.

Like any other program, microcode can have bugs and needs to be fixed; additionally, it may be desirable to add a feature to microcode. Microcode program instructions are typically stored in a read-only memory (ROM) of the microprocessor that is not directly addressable by user programs. Thus, a conventional method of fixing or feature-enhancing a microcode ROM is by patching it. The microprocessor includes patch hardware that can be written by privileged software, typically BIOS or the operating system, with a patch to effectively “replace” individual entries (instructions or data) of the microcode ROM. Typically, the privileged software loads the patch into a memory external to the microprocessor, such as BIOS memory or system memory, and then instructs the microprocessor to apply the patch from the external memory to the patch hardware in the microprocessor.

Because the memory from which the patch is loaded is external to the processor and is writeable, there is a danger that a hacker can modify the patch before it is loaded into the processor and applied to the patch hardware. For example, the hacker could start a DMA operation from a disk controller to a location in the external memory that is the location of the patch. Consequently, the processor will apply a hacked or corrupted patch that may cause the processor to operate other than intended by the processor manufacturer who wrote the patch, such as to corrupt data, destroy the processor, or perform some other malicious action.

One solution to this problem is for the processor to read the patch word by word from the external memory to perform a checksum on the patch, without applying the patch to the patch hardware in the processor. If the checksum matches, then the processor re-reads the patch from the external memory and applies the patch. That is, the solution is a two-step process: 1) verify the patch while it is still in the external memory, and 2) apply the patch to the patch hardware in the processor, if the patch verifies properly in the first step.

However, this solution still has a potential security risk because there is a window of time between when the processor performs the first step and the second step. The hacker could modify the patch during this window. In fact, the window is even wider than this because the hacker could modify the patch during the time the processor is performing the checksum as long as the hacker writes to a location that is after the location at which the processor is currently reading to perform the checksum.

One solution to reducing the likelihood of a hacker exploiting the security risk of the window described above is for the processor to perform multiple checksums in series. If the processor performs all of the multiple checksums and they all pass, then the processor has a higher degree of confidence that the patch has not been hacked.

However, for some applications, even reducing the likelihood to a relatively small size is not sufficient.

A solution that avoids the security risk of the window introduced by the two-step method described above is to effectively reverse the order of the steps. That is: 1) the processor reads the patch into the processor and applies the patch to the patch hardware; then 2) the processor performs the checksum on the patch while it is within the patch hardware inside the processor where the hacker cannot access the patch. If the patch is bad, then the processor un-applies the patch.

However, this approach may be unacceptable if it is necessary to apply multiple patches in series to the processor, i.e., to patch a patch or to apply subsequent patches after a first patch has already been applied. That is, during step 1, when the processor applies the patch to the patch hardware, the new patch may clobber portions of a previously applied good patch. Consequently, if the processor determines during step 2 that the current patch is bad, the processor has no means to repair the good patch that was clobbered by the bad patch.

Thus, a more secure solution for applying patches to microcode of microprocessors is needed.

### BRIEF SUMMARY OF INVENTION

In one aspect, the present invention provides a microprocessor having a microcode memory for storing original microcode instructions executable by the microprocessor to implement user program instructions. The microprocessor has an interface to a memory external to the microprocessor for storing a microcode patch. The microcode patch includes substitute microcode instructions and validation information. The microprocessor includes a private random access memory (PRAM), addressable by the original and substitute microcode instructions but not addressable by user program instructions. The microprocessor also includes patch hardware, coupled to the PRAM, configured to conditionally receive the substitute microcode instructions. The microprocessor is configured to execute the substitute microcode instructions when applied to the patch hardware instead of corresponding ones of the original microcode instructions. The microprocessor is configured to load the microcode patch from the external memory into the PRAM, determine whether the microcode patch within the PRAM is valid or invalid using the validation information, apply the substitute microcode instructions from the PRAM to the patch hardware if the microcode patch within the PRAM is valid, and refrain from applying the substitute microcode instructions to the patch hardware if the microcode patch within the PRAM is invalid.

In another aspect, the present invention provides a method for securely patching microcode of a microprocessor. The microprocessor has a microcode memory for storing original microcode instructions executable by the microprocessor to implement user program instructions. The microprocessor also has an interface to a memory external to the microprocessor for storing a microcode patch. The microcode patch includes substitute microcode instructions and validation information. The microprocessor also has patch hardware configured to conditionally receive the substitute microcode instructions. The microprocessor is configured to execute the substitute microcode instructions when applied to the patch hardware instead of corresponding ones of the original microcode instructions. The method includes loading the microcode patch from the external memory into a private random access memory (PRAM), wherein the PRAM is addressable by the original and substitute microcode instructions but is not addressable by user program instructions. The method includes determining whether the microcode patch within the PRAM is valid or invalid using the validation information. The method includes applying the substitute microcode instructions from the PRAM to the patch hardware, if the microcode patch within the PRAM is valid. The method also includes refraining from applying the substitute microcode instructions to the patch hardware, if the microcode patch within the PRAM is invalid.

In yet another aspect, the present invention provides a computer program product for use with a computing device. The computer program product includes a computer usable storage medium, having computer readable program code embodied in the medium, for specifying a microprocessor having a microcode memory for storing original microcode instructions executable by the microprocessor to implement user program instructions. The microprocessor also has an interface to a memory external to the microprocessor for storing a microcode patch. The microcode patch includes substitute microcode instructions and validation information. The computer readable program code includes first program code for specifying a private random access memory (PRAM), addressable by the original and substitute microcode instructions but not addressable by user program instructions. The computer readable program code also includes second program code for specifying patch hardware, coupled to the PRAM, configured to conditionally receive the substitute microcode instructions. The microprocessor is configured to execute the substitute microcode instructions when applied to the patch hardware instead of corresponding ones of the original microcode instructions. The microprocessor is configured to load the microcode patch from the external memory into the PRAM, determine whether the microcode patch within the PRAM is valid or invalid using the validation information, apply the substitute microcode instructions from the PRAM to the patch hardware, if the microcode patch within the PRAM is valid, and refrain from applying the substitute microcode instructions to the patch hardware, if the microcode patch within the PRAM is invalid.

An advantage of the present invention is that it reduces the likelihood that a microprocessor will load a bad or corrupted patch in a manner that damages an already-loaded good patch. The present invention provides a way for the microprocessor to check the integrity and compatibility of the subsequent patch, prior to applying the subsequent patch, in order to avoid affecting previously loaded good patches if the subsequent patch does not have integrity.

### BRIEF DESCRIPTION OF THE DRAWINGS

FIG. 1 is a block diagram of a related art system for loading patches into a microprocessor.

FIG. 2 is a block diagram of a system for loading patches into a microprocessor according to the present invention.

FIG. 3 is a block diagram illustrating validation information within a patch.

FIG. 4 is a block diagram illustrating a patch record within a patch.

FIG. 5 is a block diagram illustrating interaction between a patch record and the patch hardware.

FIG. 6 is a flowchart illustrating a method of loading microcode patches into the microprocessor of FIG. 2 according to the present invention.

### DETAILED DESCRIPTION OF THE INVENTION

Embodiments are described herein of a microprocessor that provides a protected storage area within the microprocessor to temporarily store and check loaded patches. The protected area is not able to be accessed by user programs to prevent them from intentionally or unintentionally attempting to modify a patch. The microprocessor loads the patch into the protected storage area and checks the integrity and compatibility of the patch while in the internal storage area before applying the patch to the patch hardware, and then applies the patch to the patch hardware only if the integrity and compatibility of the patch check out. Therefore, advantageously, if the patch gets modified in external memory, the microprocessor detects this and refrains from potentially clobbering any previously applied good patches.

Before describing embodiments of the present invention, a conventional microprocessor will now be described.

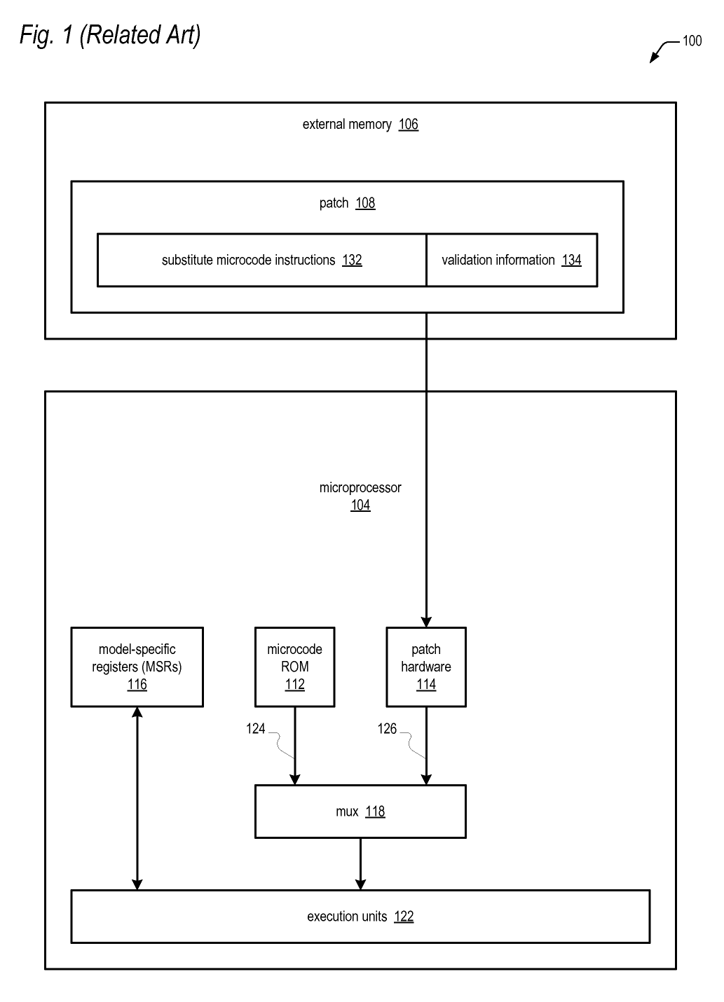

Referring now to FIG. 1, a block diagram of a related art system 100 for loading patches 108 into a microprocessor 104 is shown. The system 100 includes the microprocessor 104 and an external memory 106, which are interconnected by a bus such as a processor bus and/or memory bus. The external memory 106 contains a patch 108, where the patch 108 includes substitute microcode instructions 132 and validation information 134. The external memory 106 may contain multiple patches 108, where each patch 108 contains the substitute microcode instructions 132 and the validation information 134.

In one embodiment, the external memory 106 is a non-volatile storage device, such as Flash memory, for storing a system BIOS, for example. The system 100 or motherboard manufacturer allocates space within the non-volatile storage device for the patch 108 at the request of the microprocessor 104 manufacturer. In another embodiment, the external memory 106 is a volatile storage device such as dynamic RAM memory, and system software loads the patch 108 into the volatile memory, such as from disk storage.

Microinstructions are executed by execution units 122 of the microprocessor 104. Microinstructions are provided to the execution units 122 by a mux 118, which selects microinstructions 124 from a microcode ROM 112 or microinstructions 126 from a patch hardware 114. The patch hardware 114 contains volatile memory for storing the patches 108. Normally, microinstructions 124 from the microcode ROM 112 are selected by the mux 118. However, when the patch 108 is present in the patch hardware 114 to patch particular ones of the microinstructions 124 of the microcode ROM 112, the mux 118 instead selects the microinstructions 126 from the patch hardware 114 for those particular patched microinstructions 124. In one embodiment, privileged system software, such as BIOS or the operating system, reads and writes MSRs 116 of the microprocessor 104 to instruct the microprocessor 104 to load the patch 108 from the external memory 106 into the patch hardware 114. As an example, section 9.11 of the IA-32 Intel® Architecture Software Developer's Manual, Volume 3A: System Programming Guide, Part 1, June 2006, which is hereby incorporated by reference in its entirety for all purposes, describes the manner in which privileged software may instruct a well-known microprocessor to patch its microcode.

Unfortunately, the conventional system 100 of FIG. 1 suffers from the security and/or good-patch-clobbering problems discussed above. Embodiments of the present invention will now be described that include a solution to those problems.

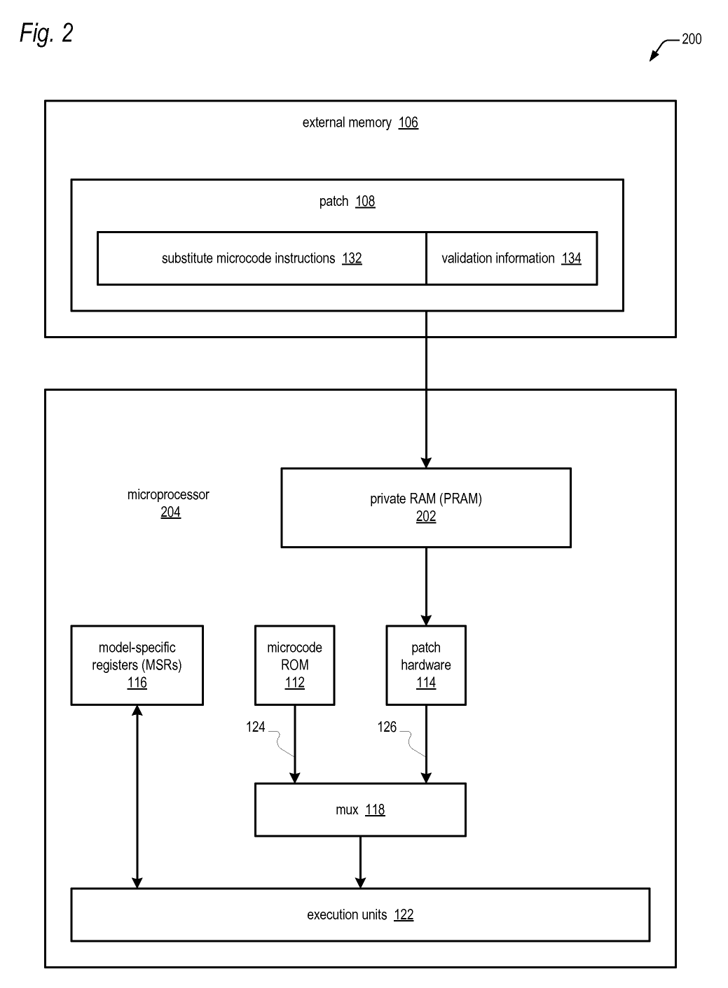

Referring now to FIG. 2, a block diagram of a system 200 for loading patches 108 into a microprocessor 204 according to the present invention is shown. The patches 108 of FIG. 2 are similar to the patches 108 of FIG. 1 and are stored in the external memory 106 as with the system 100 of FIG. 1. The microprocessor 204 of FIG. 2 includes a microcode ROM 112, patch hardware 114, MSRs 116, mux 118, and execution units 122 similar to those of FIG. 1. However, the microprocessor 204 of FIG. 2 is modified relative to the microprocessor 104 of FIG. 1 as described herein.

Unlike the microprocessor 104 of FIG. 1, the microprocessor 204 of FIG. 2 includes a private RAM (PRAM) 202, which is a volatile memory that is used to store the patches 108 loaded by the microprocessor 204 from the external memory 106. In one embodiment, the microprocessor 204 loads the patches 108 from a starting address in the external memory 106 that the privileged software specifies in one of the MSRs 116. The microprocessor 204 then selectively loads the patch 108 from the PRAM 202 to the patch hardware 114 based on whether the patch 108 passes its validity checks, as will be discussed below. The PRAM 202 resides in its own non-user-accessible address space of the microprocessor 204 that is separate from the user memory address space of the microprocessor 204. The PRAM 202 is not addressable by user code instructions, but is only addressable by the microprocessor 204, such as via the instructions 124 stored in the microcode ROM 112. In one embodiment, the microprocessor 204 includes distinct microinstructions in its microinstruction set for accessing the PRAM 202.

After the microprocessor 204 loads the patch 108 into the PRAM 202, the microprocessor 204 performs validity checks on the patch 108, prior to loading the patch 108 from the PRAM 202 to the patch hardware 114. The patch hardware 114 may comprise embodiments described in the following commonly assigned pending U.S. patent applications, each of which is hereby incorporated by reference in its entirety for all purposes: Ser. Nos. 11/782,062; 11/782,072; 11/782,081; 11/782,088; 11/782,094; 11/782,099; 11/782,105 (CNTR.2292, 2407-2412), each filed on Jul. 24, 2007.

There are at least two advantages to performing these checks in the PRAM 202. First, the checks may be performed within the microprocessor 204, where external software may not tamper with the patch 108. Therefore, once the microprocessor 204 has performed validity checks on the patch 108 and determined that the patch 108 is good, the patch 108 may not be modified prior to the microprocessor 204 applying the patch 108. Second, by performing the validity checks in the PRAM 202, the patch 108 may be isolated from the patch hardware 114. That is, if the validity checks should fail, the microprocessor 204 may refrain from applying the patch 108 to the patch hardware 114 without clobbering previously applied good patches in the patch hardware 114. In the conventional approach of FIG. 1, a bad patch 108 could corrupt the patch 108 stored in the patch hardware 114, and possibly make it difficult or impossible to recover to a previously loaded good patch 108. With the present invention, a corrupt patch 108 would not reach the patch hardware 114 since it would be detected as a bad patch 108 within the PRAM 202 and prior to copying the patch 108 in the PRAM 202 to the patch hardware 114. Furthermore, the validity checks may potentially be performed faster in the PRAM 202 than in the external memory 106 since the PRAM 202 is internal to the microprocessor 204.

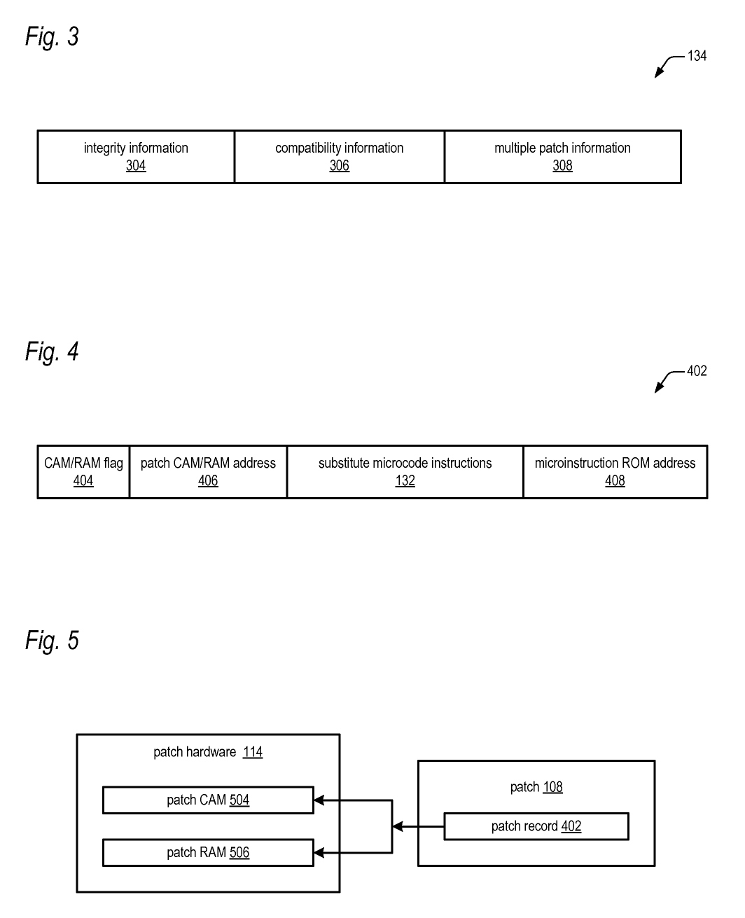

Referring now to FIG. 3, a block diagram illustrating the validation information 134 within a patch 108 of FIG. 2 is shown. The validation information 134 may include stored integrity information 304 such as parity, CRC, signature, and/or checksum information. The microprocessor 204 reads all bytes of the patch 108 from the PRAM 202 of FIG. 2 and computes integrity information for the entire patch 108. The computed integrity information is then compared to the stored integrity information 304 in the validation information 134. If the computed integrity information matches the stored integrity information 304, the patch 108 is a good patch 108; otherwise the patch 108 is not a good patch 108. Multiple and possibly different types of integrity checks may be made by the microprocessor 204. In one embodiment, the microprocessor 204 invokes microcode routines to perform the integrity checks.

The validation information 134 may include compatibility information 306 such as the microprocessor 204 type and stepping, the patch 108 version, the patch 108 date code, or any other type of information that can be used to check compatibility of the patch 108 for the microprocessor 204. The microprocessor 204 reads the patch 108 compatibility information 306 from the PRAM 202 and compares to compatibility information stored within the microcode ROM 112 or other non-volatile storage of the microprocessor 204. If the patch 108 compatibility information 306 does not match the stored compatibility information 306, the patch 108 is not a good patch 108. Multiple and possibly different types of compatibility checks may be made by the microprocessor 204.

The validation information 134 may include multiple patch information 308. The multiple patch information 308 indicates to the microprocessor 204 that at least one additional patch 108 is to be loaded after the current patch 108. The multiple patch information 308 may also indicate the starting address for the next patch 108 to be loaded.

Referring now to FIG. 4, a block diagram illustrating a patch record 402 within a patch 108 of FIG. 2 is shown. The patch 108 includes one or more patch records 402, with one patch record 402 per substitute microcode instruction 132 in the patch 108. The patch record 402 includes a CAM/RAM flag 404, which specifies whether the patch record 402 is destined for either a patch CAM 504 or a patch RAM 506 (shown in FIG. 5) within the patch hardware 114. The patch record 402 also includes a substitute microcode instruction field 132 that includes the microinstruction or data that will replace a microinstruction or data stored in the microcode ROM 112. The patch record 402 also includes a microinstruction ROM address 408, which is the address in the microcode ROM 112 of the microinstruction that will be replaced by the substitute microcode instruction 132. The patch record 402 also includes a patch CAM/RAM address 406. If the CAM/RAM flag 404 indicates the patch RAM 506, then the microprocessor 204 writes the substitute microcode instruction 132 to the patch RAM 506 at the address specified in the patch CAM/RAM address field 406. If the CAM/RAM flag 404 indicates the patch CAM 504, then the microprocessor 204 writes the microcode ROM address 408 and the substitute microcode instruction 132 to the patch CAM 504 at the address specified in the patch CAM/RAM address field 406.

Referring now to FIG. 5, a block diagram illustrating interaction between a patch record 402 and the patch hardware 114 is shown. The patch 108 includes one or more patch records 402 of FIG. 4. The patch hardware 114 includes the patch CAM 504 and the patch RAM 506. The patch CAM 504 is a content-addressable memory, each entry of which stores a microcode ROM 112 addresses and associated substitute microcode instruction 132 pair. The patch RAM 506 is volatile memory, each entry of which stores a substitute microcode instruction 132. The patch RAM 506 is mapped adjacent to the microcode ROM 112 within the microcode address space. In other words, the patch RAM 506 locations are treated as an extension of the microcode ROM 112 within the microcode address space. A given patch record 402 is stored in either the patch CAM 504 or the patch RAM 506, but not both, depending on the state of the CAM/RAM flag 404, as described above. In one embodiment, the patch CAM 504 has 32 entries and the patch RAM 506 has 256 entries.

The microprocessor 204 generates a fetch address to the microcode ROM 112 and patch RAM 506 to fetch a microcode instruction from one of them. In parallel, the patch CAM 504 looks up the fetch address. Each patch CAM 504 entry can be mapped to any location in the microcode ROM 112. If the fetch address hits in the patch CAM 504 (i.e., the fetch address is the same as one of the valid entries in the patch CAM 504), the patch CAM 504 provides the associated instruction word 126 and the mux 118 of FIG. 2 selects the instruction word 126 from the patch CAM 504 for provision to the execution units 122 rather than the instruction word 124 provided by the microcode ROM 112 or patch RAM 506. Otherwise, if the fetch address specifies a location within the address range associated with the microcode ROM 112 or the patch RAM 506, then the microcode ROM 112 or patch RAM 506 provides the instruction word 126, which the mux 118 selects for provision to the execution units 122.

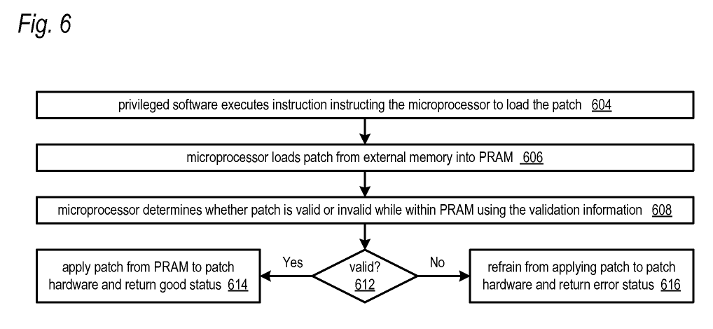

Referring now to FIG. 6, a flowchart illustrating a method of loading microcode patches into the microprocessor 200 of FIG. 2 according to the present invention is shown. Prior to loading the patches 108 into the microprocessor 204, the patches 108 are installed or loaded into the external memory 106 of the system 200 of FIG. 2. The patches 108 are installed in the external memory 106 as part of a maintenance procedure to fix bugs or add functionality to the microprocessor 204. Flow begins at block 604.

At block 604, privileged software executes one or more instructions that instruct the microprocessor 204 to load the patch 108 from the external memory 106. In one embodiment, in response to these instructions, the microprocessor 204 executes a microcode sequence to initiate patch 108 loading. In one embodiment, the system software reads and writes the MSRs 116 of FIG. 2 in a sequence similar to the manner described in section 9.11 of the IA-32 Intel® Architecture Software Developer's Manual, Volume 3A, referenced above. In one embodiment, rather than in response to privileged software instructions, the microprocessor 204 performs the patch loading procedure described with respect to FIG. 6 in response to a reset of the microprocessor 204 to load a patch 108 from a predetermined location in the external memory 106. Flow proceeds to block 606.

At block 606, the microprocessor 204 loads the patch 108 from the external memory 106 into the PRAM 202. In one embodiment, the microprocessor 204 loads the patch 108 into the PRAM 202 from a starting address in the external memory 106 specified by the privileged software in one of the MSRs 116. In one embodiment, microcode in the microprocessor 204 loads the patch 108 from the external memory 106 into the PRAM 202 through a temporary register in the microprocessor 204. That is, a microcode load instruction loads a byte or word of the patch 108 from the external memory 106 into a temporary register of the microprocessor 204 and then a microcode store instruction stores the byte or word of the patch from the temporary register to the PRAM 202, and the microcode continues this load/store operation until it has loaded the entire patch 108 into the PRAM 202. Flow proceeds to block 608.

At block 608, the microprocessor 204 determines whether the patch 108 is valid or invalid while within the PRAM 202 using the patch 108 validation information 134 of FIG. 3. Flow proceeds to decision block 612.

At decision block 612, if the microprocessor 204 determines the patch 108 is valid based on the determination made at block 608, then flow proceeds to block 614; otherwise, flow proceeds to block 616.

At block 614, all checks using the validation information 134 have been completed, and the patch 108 has been determined to be a good patch 108 by the microprocessor 204. The microprocessor 204 applies the patch 108 from the PRAM 202 to the patch hardware 114, and returns good status. In one embodiment, returning good status comprises setting a flag in a register of the microprocessor 204 that indicates the patch 108 has been successfully loaded to the patch hardware 114. In another embodiment, returning good status comprises setting a first flag in a register of the microprocessor 204 that indicates verified integrity information and setting a second flag in a register of the microprocessor 204 that indicates verified compatibility information and setting a third flag in a register of the microprocessor 204 that indicates the patch 108 has been successfully loaded to the patch hardware 114. Once the patch 108 has been loaded from the PRAM 202 to the patch hardware 114 and good status is returned, the microprocessor 204 uses the patch 108 when fetching microcode instructions. Flow ends at block 614.

At block 616, all checks using the validation information 134 have been completed, and the patch 108 has been determined to not be a good patch 108 by the microprocessor 204. The microprocessor 204 therefore refrains from applying the patch 108 to the patch hardware 114 and returns an error status. Advantageously, this potentially avoids clobbering a good patch within the patch CAM 504 and/or patch RAM 506. Flow ends at block 616.

While various embodiments of the present invention have been described herein, it should be understood that they have been presented by way of example, and not limitation. It will be apparent to persons skilled in the relevant computer arts that various changes in form and detail can be made therein without departing from the scope of the invention. For example, software can enable, for example, the function, fabrication, modeling, simulation, description and/or testing of the apparatus and methods described herein. This can be accomplished through the use of general programming languages (e.g., C, C++), hardware description languages (HDL) including Verilog HDL, VHDL, and so on, or other available programs. Such software can be disposed in any known computer usable medium such as semiconductor, magnetic disk, or optical disc (e.g., CD-ROM, DVD-ROM, etc.). Embodiments of the apparatus and method described herein may be included in a semiconductor intellectual property core, such as a microprocessor core (e.g., embodied in HDL) and transformed to hardware in the production of integrated circuits. Additionally, the apparatus and methods described herein may be embodied as a combination of hardware and software. Thus, the present invention should not be limited by any of the herein-described exemplary embodiments, but should be defined only in accordance with the following claims and their equivalents. Specifically, the present invention may be implemented within a microprocessor device which may be used in a general purpose computer. Finally, those skilled in the art should appreciate that they can readily use the disclosed conception and specific embodiments as a basis for designing or modifying other structures for carrying out the same purposes of the present invention without departing from the scope of the invention as defined by the appended claims.

We claim:

1. A microprocessor, having a microcode memory for storing original microcode instructions executable by the microprocessor to implement user program instructions, the microprocessor also having an interface to a memory external to the microprocessor for storing a microcode patch, the microcode patch including substitute microcode instructions and validation information, the microprocessor comprising:
a private random access memory (PRAM), addressable by the original and substitute microcode instructions but not addressable by user program instructions; and
patch hardware, coupled to the PRAM, configured to conditionally receive the substitute microcode instructions, wherein the microprocessor is configured to execute the substitute microcode instructions when applied to the patch hardware instead of corresponding ones of the original microcode instructions;
wherein the microprocessor is configured to:
load the microcode patch from the external memory into the PRAM;
determine whether the microcode patch within the PRAM is valid or invalid using the validation information;
apply the substitute microcode instructions from the PRAM to the patch hardware, if the microcode patch within the PRAM is valid; and
refrain from applying the substitute microcode instructions to the patch hardware, if the microcode patch within the PRAM is invalid.

2. The microprocessor of claim 1, wherein the microprocessor is configured to load the microcode patch from the external memory into the PRAM in response to the microprocessor executing one or more of the user program instructions that instruct the microprocessor to load the microcode patch.

3. The microprocessor of claim 2, wherein the one or more of the user program instructions that instruct the microprocessor to load the microcode patch comprise at least one instruction that accesses a model-specific register (MSR) of the microprocessor.

4. The microprocessor of claim 3, wherein the one or more of the user program instructions that instruct the microprocessor to load the microcode patch comprise at least one instruction that loads an address into a model-specific register (MSR) of the microprocessor, wherein the address is the starting address of the microcode patch in external memory.

5. The microprocessor of claim 1, wherein the microprocessor is configured to load the microcode patch from the external memory into the PRAM in response to a reset of the microprocessor.

6. The microprocessor of claim 1, wherein the validation information comprises a checksum of the microcode patch, wherein the microprocessor is configured to determine whether the microcode patch within the PRAM is valid or invalid using the validation information by computing a checksum of the microcode patch in the PRAM and comparing the computed checksum with the microcode patch checksum.

7. The microprocessor of claim 1, wherein the validation information comprises a cyclic redundancy code (CRC) of the microcode patch, wherein the microprocessor is configured to determine whether the microcode patch within the PRAM is valid or invalid using the validation information by computing a CRC of the microcode patch in the PRAM, and comparing the computed CRC with the microcode patch CRC.

8. The microprocessor of claim 1, wherein the validation information comprises a signature of the microcode patch, wherein the microprocessor is configured to determine whether the microcode patch within the PRAM is valid or invalid using the validation information by comparing a known signature manufactured within the microprocessor with the microcode patch signature.

9. The microprocessor of claim 1, wherein the PRAM comprises a dynamic RAM.

10. The microprocessor of claim 1, wherein microcode in the microprocessor is configured to:
load the microcode patch from the external memory into the PRAM;
determine whether the microcode patch within the PRAM is valid or invalid using the validation information;
apply the substitute microcode instructions from the PRAM to the patch hardware, if the microcode patch within the PRAM is valid; and
refrain from applying the substitute microcode instructions to the patch hardware, if the microcode patch within the PRAM is invalid.

11. The microprocessor of claim 1, wherein the microprocessor is configured to:
load a second microcode patch from the external memory into the PRAM, after applying the substitute microcode instructions of the first microcode patch to the patch hardware;
determine whether the second microcode patch within the PRAM is valid or invalid using the validation information of the second microcode patch;
apply the substitute microcode instructions of the second microcode patch from the PRAM to the patch hardware, if the second microcode patch within the PRAM is valid; and
refrain from applying the substitute microcode instructions of the second microcode patch to the patch hardware, if the second microcode patch within the PRAM is invalid.

12. The microprocessor of claim 11, wherein the validation information of the first microcode patch includes the starting address in external memory of the second microcode patch.

13. The microprocessor of claim 11, wherein applying the substitute microcode instructions of the second microcode patch from the PRAM to the patch hardware comprises clearing an error flag in the microprocessor.

14. The microprocessor of claim 11, wherein refraining from applying the substitute microcode instructions of the second microcode patch to the patch hardware comprises setting an error flag in the microprocessor.

15. A method for securely patching microcode of a microprocessor, the microprocessor having a microcode memory for storing original microcode instructions executable by the microprocessor to implement user program instructions, the microprocessor also having an interface to a memory external to the microprocessor for storing a microcode patch, the microcode patch including substitute microcode instructions and validation information, the microprocessor also having patch hardware configured to conditionally receive the substitute microcode instructions, wherein the microprocessor is configured to execute the substitute microcode instructions when applied to the patch hardware instead of corresponding ones of the original microcode instructions, the method comprising:
loading the microcode patch from the external memory into a private random access memory (PRAM), wherein the PRAM is addressable by the original and substitute microcode instructions but is not addressable by user program instructions;
determining whether the microcode patch within the PRAM is valid or invalid using the validation information;
applying the substitute microcode instructions from the PRAM to the patch hardware, if the microcode patch within the PRAM is valid; and
refraining from applying the substitute microcode instructions to the patch hardware, if the microcode patch within the PRAM is invalid.

16. The method of claim 15, wherein said loading the microcode patch from the external memory into the PRAM is performed in response to the microprocessor executing one or more of the user program instructions that instruct the microprocessor to load the microcode patch.

17. The method of claim 16, wherein the one or more of the user program instructions that instruct the microprocessor to load the microcode patch comprise at least one instruction that accesses a model-specific register (MSR) of the microprocessor.

18. The method of claim 17, wherein the one or more of the user program instructions that instruct the microprocessor to load the microcode patch comprise at least one instruction that loads an address into a model-specific register (MSR) of the microprocessor, wherein the address is the starting address of the microcode patch in external memory.

19. The method of claim 15, wherein said loading the microcode patch from the external memory into the PRAM is performed in response to a reset of the microprocessor.

20. The method of claim 15, wherein the validation information comprises a checksum of the microcode patch, wherein said determining whether the microcode patch within the PRAM is valid or invalid using the validation information comprises computing a checksum of the microcode patch in the PRAM and comparing the computed checksum with the microcode patch checksum.

21. The method of claim 15, wherein the validation information comprises a cyclic redundancy code (CRC) of the microcode patch, wherein said determining whether the microcode patch within the PRAM is valid or invalid using the validation information comprises computing a CRC of the microcode patch in the PRAM, and comparing the computed CRC with the microcode patch CRC.

22. The method of claim 15, wherein the validation information comprises a signature of the microcode patch, wherein said determining whether the microcode patch within the PRAM is valid or invalid using the validation information comprises comparing a known signature manufactured within the microprocessor with the microcode patch signature.

23. The method of claim 15, wherein the PRAM comprises a dynamic RAM.

24. The method of claim 15, wherein said loading, determining, applying, and refraining are performed by microcode of the microprocessor.

25. The method of claim 15, further comprising:
loading a second microcode patch from the external memory into the PRAM, after said applying the substitute microcode instructions of the first microcode patch to the patch hardware;
determine whether the second microcode patch within the PRAM is valid or invalid using the validation information of the second microcode patch;
applying the substitute microcode instructions of the second microcode patch from the PRAM to the patch hardware, if the second microcode patch within the PRAM is valid; and
refraining from applying the substitute microcode instructions of the second microcode patch to the patch hardware, if the second microcode patch within the PRAM is invalid.

26. The method of claim 25, wherein applying the substitute microcode instructions of the second microcode patch from the PRAM to the patch hardware comprises clearing an error flag in the microprocessor.

27. The method of claim 25, wherein refraining from applying the substitute microcode instructions of the second microcode patch to the patch hardware comprises setting an error flag in the microprocessor.

28. A computer program product for use with a computing device, the computer program product comprising:
a computer usable storage medium, having computer readable program code embodied in said medium, for specifying a microprocessor having a microcode memory for storing original microcode instructions executable by the microprocessor to implement user program instructions, the microprocessor also having an interface to a memory external to the microprocessor for storing a microcode patch, the microcode patch including substitute microcode instructions and validation information, the computer readable program code comprising:
first program code for specifying a private random access memory (PRAM), addressable by the original and substitute microcode instructions but not addressable by user program instructions; and
second program code for specifying patch hardware, coupled to the PRAM, configured to conditionally receive the substitute microcode instructions, wherein the microprocessor is configured to execute the substitute microcode instructions when applied to the patch hardware instead of corresponding ones of the original microcode instructions;
wherein the microprocessor is configured to:
load the microcode patch from the external memory into the PRAM;
determine whether the microcode patch within the PRAM is valid or invalid using the validation information;
apply the substitute microcode instructions from the PRAM to the patch hardware, if the microcode patch within the PRAM is valid; and
refrain from applying the substitute microcode instructions to the patch hardware, if the microcode patch within the PRAM is invalid.
